(19) United States
(12) Patent Application Publication
(10) Pub. No.: US 2022/0394070 A1
(43) Pub. Date: Dec. 8, 2022

(54) MULTI-CONVERSATIONAL SOCIAL NETWORKING

(71) Applicant: GARY STEVEN POGODA, Atlantic City, NJ (US)

(72) Inventor: GARY STEVEN POGODA, Atlantic City, NJ (US)

(73) Assignee: GARY STEVEN POGODA, Atlantic City, NJ (US)

(21) Appl. No.: 17/829,278

(22) Filed: May 31, 2022

Related U.S. Application Data
(60) Provisional application No. 63/202,238, filed on Jun. 2, 2021.

(51) Int. Cl. H04L 65/403; G10L 13/08

(52) U.S. Cl. CPC H04L 65/4046; G10L 13/08

(57) ABSTRACT

This invention relates to a social networking application for emulating a multi-conversational event space.

### CROSS-REFERENCE TO RELATED APPLICATION

This application claims the benefit of U.S. Provisional Application No. 63/202,238, filed Jun. 2, 2021.

### BACKGROUND OF THE INVENTION

The present invention is directed toward a social networking application, and more specifically, toward one that emulates a multi-conversational event space.

For current social networking applications, a computer server is typically used to individually receive a data stream from each event participant, mix them down to one data stream, and then transmit that one data stream to the entire event. As such, every event participant will hear every other event participant at full speaking volume, so it would be extremely difficult to simultaneously hold multiple conversations in the same event space.

Conversely, with real restaurant dining rooms, where dining patrons hear each other at speaking volumes that have been individually attenuated in proportion to their dining room separation, conversations from nearby tables will not interfere with the conversation at your own table, thus enabling NUMEROUS conversations to be ongoing simultaneously in the same room. However, emulating this type of multi-conversational event space would require an individual communication channel for each dining patron, which, for events with any more than just a few dining patrons, would easily exceed the communication bandwidth of the personal-type computing devices, typically utilized for social networking.

The present invention overcomes this limitation by converting the speech of each dining room speaker to text, and transmitting that text (in place of the original audio) to each dining room listener with whom that speaker is NOT directly conversing. Each indirect listener then converts that text to synthesized speech, and independently attenuates its volume in proportion to the dining room separation of that speaker/listener pair. In this manner, much of the previously transmitted audio is now replaced with text, which requires significantly less communication bandwidth than audio, thereby making the present invention ideally suited for AUDIO social networking on all types of personal computing devices, including, but not limited to, PCs, smartphones, and tablets.

With VIDEO social networking, however, there are no low-bandwidth data streams that can be transmitted in place of their high-bandwidth counterparts, hence the typical ‘Hollywood Squares’ type video arrangements of those applications. While such arrangements are perfectly suitable for applications where everyone is participating in one big conversation, for the multi-conversational event space of the present invention, it would be preferable to selectively display only those videos that an event participant actually hears at full volume. Unfortunately, this type of video selectivity would require an individual data stream for each such video, which would, again, easily exceed the communication bandwidth of the personal-type computing devices typically utilized for social networking.

The present invention overcomes this limitation with a request-to-talk type setup (which can be voice, motion, or otherwise activated by a user), such that any one event participant can request on, for example, a first-come-first-served basis, to become the designated speaker for the group of event participants that the one event participant is currently hearing at full volume. Such a grouping might occur if the group participants are seated in close proximity to the one participant, or simply by user selection.

If the granting criteria are met, the request is granted, and the data stream of the designated speaker is then independently transmitted to that entire group. In this manner, only one data stream would ever need to be transmitted to an event participant at any given time, thereby making the present invention ideally suited for VIDEO social networking, as well.

While the preferred embodiment, herein disclosed, is specific to restaurant dining rooms, it should be noted that the present invention broadly applies to any type of social networking where multiple conversations are to be ongoing simultaneously in the same event space, as would be the case with parties, reunions, meetings, conventions, trade shows, and the like. It should be further noted that, while the present disclosure depicts the most basic functionality for this invention, it would be obvious to one skilled in the art, that this functionality could be easily enhanced. Such enhancements might include: music/video synchronized to all dining patrons; background dining room crowd noise; and private conversations, just to name a few.

### SUMMARY OF THE INVENTION

This invention relates to a social networking application for emulating a multi-conversational event space.

### BRIEF DESCRIPTION OF THE DRAWINGS

To illustrate this invention, there are shown in the accompanying drawings, embodiments that are presently preferred, it being understood that the invention is not intended to be limited to the precise arrangements and instrumentalities shown.

FIG. 1 is a restaurant dining room embodiment of the invention.

FIG. 2 is a flowchart of a multi-conversational scenario for FIG. 1.

FIG. 3 is a flowchart of a request-to-talk scenario for FIG. 1.

### DETAILED DESCRIPTION OF THE PREFERRED EMBODIMENTS

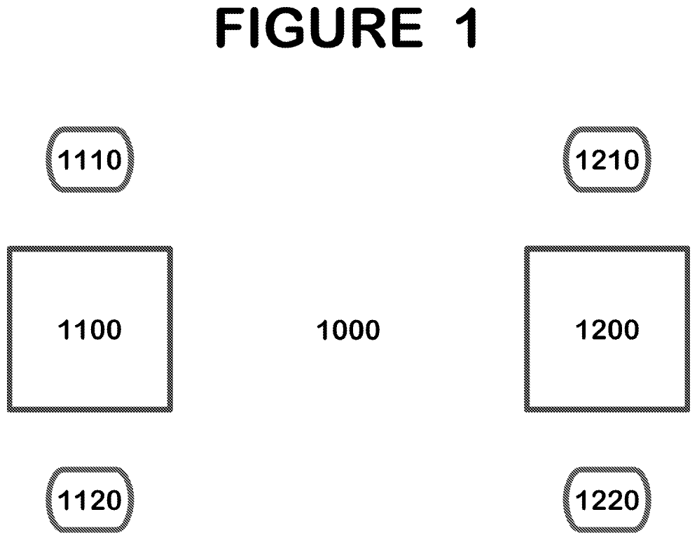

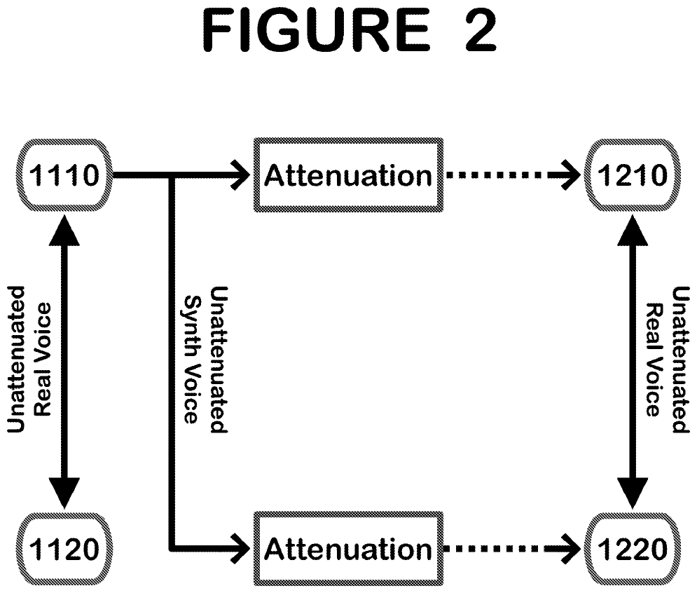

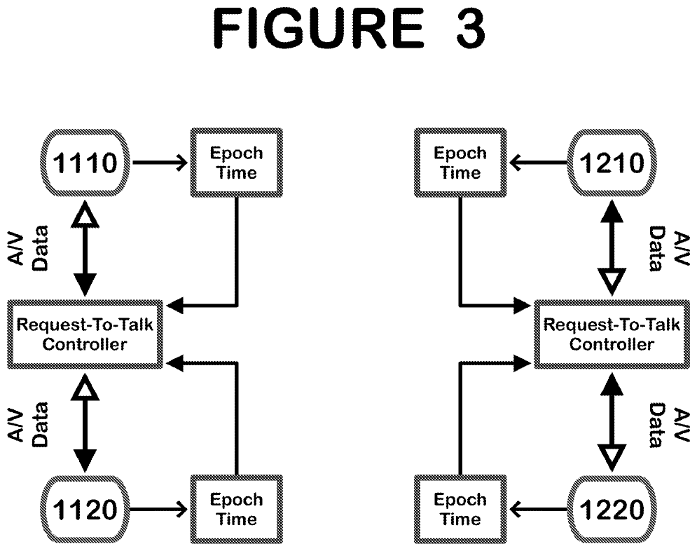

Referring now to the details of the accompanying drawings, wherein like reference numerals have been used throughout for designating like elements, there is shown from a top view perspective in FIG. 1, a restaurant dining room 1000, with two dining tables 1100 and 1200, and four dining patrons 1110, 1120, 1210, and 1220. FIG. 2 shows the flowchart 2000 of a multi-conversational scenario for FIG. 1, and FIG. 3 shows the flowchart 3000 of a request-to-talk scenario for FIG. 2.

In FIG. 1, there is shown a first 1110 and second 1120 dining patron seated at a dining table 1100 in the restaurant dining room 1000, and a third 1210 and fourth 1220 dining patron seated at another dining table 1200 in that restaurant dining room 1000. In a real restaurant dining room, dining patrons seated at the same table would, due to their proximate seating, hear each other's unattenuated speech, whereas dining patrons seated at nearby tables would, due to their less proximate seating, hear each other's speech after it has been attenuated in proportion to the distance between them in dining room.

In FIG. 2, using the seating arrangement of FIG. 1, the first 1110 and second 1120 dining patrons are shown directly conversing with each other, using their unattenuated real voices, as are the third 1210 and fourth 1220 dining patrons.

Also in FIG. 2, the first 1110 dining patron is shown indirectly speaking to the third 1210 and fourth 1220 dining patrons, using its synth voice (obtained from its real voice after speech-to-text and then text-to-speech conversion), being independently attenuated for each speaker/listener pair 1110/1210 and 1110/1220 in proportion to their dining room 1000 separation. The remaining dining patrons 1120, 1210, and 1220 are similarly (but not shown) speaking indirectly to their counterparts.

As such, dining patrons seated in close proximity, will hear one another unattenuated; whereas, dining patrons seated less proximately, will hear one another individually attenuated in proportion to each pair's dining room separation, just like in a real restaurant dining room.

While the present embodiment emulates a very small dining room, these same emulation techniques can be applied to rooms of any size and type. Furthermore, while the present embodiment shows just two dining patrons participating in each of the unattenuated direct conversations, it is certainly possible, and likely, that more than two dining patrons would be directly conversing with each other.

For example, four dining patrons, seated at the same table, could, due to their proximate seating, be directly conversing unattenuated, just like in a real restaurant dining room, whereas any number of dining patrons seated at surrounding tables could, due to their less proximate seating, be indirectly hearing that conversation attenuated, also just like in a real restaurant dining room.

Additionally, other dining patrons, regardless of their spatial seating, could be conversing directly or indirectly, and attenuated or unattenuated, simply as a matter of user selection.

In FIG. 3, using the seating arrangement, and the indirect speaking connections (not shown), of FIG. 2, a group of dining patrons, consisting of the first 1110 and second 1120 dining patrons, is shown transmitting their audio/video data to each other, as is another group of dining patrons, consisting of the third 1210 and fourth 1220 dining patrons. While these data flows are bidirectional, they can flow in only one direction at any given time, namely, from the designated speaker of each group at that time, that designated speaker being determined, as follows.

When a dining patron in a group requests to speak, it sends its epoch time to the request-to-speak controller for that group, which will then grant these requests on a first-come-first-served basis, as long as any such previously granted request has been relinquished. Whenever a request is granted, the requesting dining patron becomes the designated speaker for that group, and its audio/video data is transmitted to all the other dining patrons in the group, thus enabling them to see and hear the designated speaker. As shown in FIG. 3, the first 1110 and fourth 1220 dining patrons are the designated speakers for their respective groups, and the second 1120 and third 1210 dining patrons are, respectively, receiving their transmitted audio/video data.

The reason that epoch time is used in FIG. 3 to determine if a request to speak should be granted, is because the dining patrons 1110, 1120, 2110, and 2120 are connected via the internet, with up to several seconds of lag, so it would be difficult to make decisions that require sub-second accuracy without an absolute time reference.

For FIG. 3, requests to speak are granted on a first-come-first-served basis; however, these requests could just as easily have been granted based on other criteria, as well. For example, requests could have been granted based on the seniority of the requestor, based on the alphabetical listing of the requestor, based on the number of previous requests made by the requestor, or even arbitrarily, just to name a few.

I claim:

1. Social networking application means, where said application means can, at least in part, emulate a multi-conversational event space.

2. The application means of claim 1, where said emulation can include a plurality of participants, where said participants can include at least one speaker/listener pair, where some portion of the speech of said speaker of at least one said pair can be converted to text, where some portion of said text can be transmitted to said listener of said pair, where some portion of said transmitted text can be received by said listener, where some portion of said received text can be converted to synthesized speech, and where the volume of some portion of said synthesized speech can be independently attenuated.

3. The application means of claim 2, where said attenuation can, at least in part, be in accordance with a spatial relationship between said pair.

4. The application means of claim 3, where said relationship can, at least in part, be in accordance with the separation of said pair in said event space.

5. The application means of claim 2, where said attenuation can, at least in part, be in accordance with user selection.

6. The application means of claim 1, where some portion of said event space can be a restaurant dining room.

7. The application means of claim 6, where said emulation can include a plurality of dining patrons, where said patrons can include at least one speaker/listener pair, where some portion of the speech of said speaker of at least one said pair can be converted to text, where some portion of said text can be transmitted to said listener of said pair, where some portion of said transmitted text can be received by said listener, where some portion of said received text can be converted to synthesized speech, and where the volume of some portion of said synthesized speech can be independently attenuated.

8. The application means of claim 7, where said attenuation can, at least in part, be in accordance with a spatial relationship between said pair.

9. The application means of claim 8, where said relationship can, at least in part, be in accordance with the separation of said pair in said dining room.

10. The application means of claim 7, where said attenuation can, at least in part, be in accordance with user selection.

11. Social networking application means that can include a plurality of participants, where some portion of said participants can include one or more groups, where at least one of said participants, from at least one of said groups, can request to become, at least temporarily, a designated speaker for said group, where if said request is granted, it can cause some portion the audio/video data of said designated speaker to be independently transmitted to some portion of said group of said designated speaker.

12. The application means of claim 11, where said grouping can, at least in part, be in accordance with a spatial relationship amongst said group.

13. The application means of claim 11, where said grouping can, at least in part, be in accordance with user selection.

14. The application means of claim 11, where said request can, at least in part, be automatically initiated by said requestor's voice upon speaking.

15. The application means of claim 11, where said request can, at least in part, be manually initiated by said requestor.

16. The application means of claim 11, where said request can, at least in part, be granted on a first-come-first-served basis.
